(19) United States
(12) Patent Application Publication
(10) Pub. No.: US 2012/0072938 A1
(43) Pub. Date: Mar. 22, 2012

(54) SYSTEM AND METHOD FOR PROVIDING A SERVICE OR CONTENT BASED ON EMOTIONAL INFORMATION

(75) Inventors: Nak-Seon SEONG, Daejeon-si (KR); Myung-Ae CHUNG, Daejeon-si (KR)

(73) Assignee: ELECTRONIC AND TELECOMMUNICATIONS RESEARCH INSTITUTE, Daejeon (KR)

(21) Appl. No.: 13/237,140

(22) Filed: Sep. 20, 2011

(30) Foreign Application Priority Data
Sep. 20, 2010 (KR) 10-2010-0092529

(51) Int. Cl. H04H 60/33

(52) U.S. Cl. 725/10

(57) ABSTRACT

Provided are an apparatus and method for providing a service or content based on emotional information. A service receiving apparatus extracts and analyzes emotional information of a received service or content to use the corresponding service or content according to an environment that is set.

### CROSS-REFERENCE TO RELATED APPLICATION

This application claims the benefit under 35 U.S.C. §119(a) of a Korean Patent Application No. 10-2010-0092529, filed on Sep. 20, 2010, entire disclosure of which is incorporated herein by reference for all purposes.

### BACKGROUND

1. Field

The following description relates to an apparatus and method for providing a service or content based on emotional information.

2. Description of the Related Art

Human' emotions or feelings depend on an individual's character. Psychological factors that have influence over human's emotions can be greatly classified into surprise, fear, disgust, anger, joy, happiness, sadness, etc., and individuals express or transfer their emotions or feelings in various ways.

The human's emotions or feelings have been discussed only as personal information so far. However, recently, trials for providing customized services based on emotional information are being conducted. In particular, studies into a service model for broadcasting an individual's hidden emotions to a specific group, a specific person, a specific web site member, a specific device's owner, an emotion group whose members share a specific emotion, persons located in a specific region, a family, a society, and a country are actively in progress.

With development and convergence of broadcasting and communication technologies, various kinds of contents are provided to receivers. For example, mobile digital broadcasting technologies including Digital Multimedia Broadcasting (DMB) allow users to view broadcast programs while moving. With help of development of mobile digital broadcasting technologies, various broadcast services are provided to users. Specifically, interactive or intelligent broadcasting services allow receivers to directly participate in broadcasting.

However, a method of transmitting realistic, real-time emotional information to a receiver upon transmission of broadcasting/communication information has not been developed so far.

Although emotions collected through interactions between persons vary in consideration of various factors including social common laws, national characters, etc., emotional information, which is provided by a broadcasting service model, still needs to reflect an individual's personal tendencies and character since persons may get different emotions or different degrees of emotion against the same situation according to their tendencies and character. Accordingly, studies into an enhanced service model capable of providing appropriate responses in consideration of an individual's personal emotions are needed.

### SUMMARY

The following description relates to an emotional information reception/transmission apparatus for transmitting/receiving emotional information to/from a remote receiver, and an emotional information reception/transmission method thereof

The following description also relates to an apparatus and method for analyzing or extracting emotional information that a service or content itself represents. The emotional information may be included in a service or content or can be recognized from a service or content.

The following description also relates to an apparatus and method for displaying content including emotional information according to a user's desired environment.

The following description also relates to an apparatus and method for extracting emotional information that content itself represents directly from a user's device and controlling the emotional information according to conditions requested by the user.

In one general aspect, there is provided a service providing apparatus including: a content analyzer configured to analyze emotional information from first content including the emotional information; and a user content creator configured to convert the first content to second content using the analyzed emotional information, the second content having emotional information suitable for a user environment according to which the user wants to consume content.

The user content creator may convert the first content to the second content in a manner to receive or exclude only a part including specific emotional information in the first content.

The service providing apparatus may further include a user environment setting unit configured to set the user environment under which a part including specific emotional information in the first content is able to be controlled.

The service providing apparatus may further include a content output unit configured to output the second content.

The service providing apparatus may further include: an emotion analysis unit configured to estimate emotional information from third content including no emotional information; and an emotion content creator configured to include the estimated emotional information in the third content, thus creating the third content including the emotional information as the first content.

The service providing apparatus may further include database configured to store information about a user's preferences representing a user environment according to which the user wants to consume content, wherein the user content creator converts the first content to the second content using the information about the user' preferences.

In another general aspect, there is provided a service providing apparatus including: a content analysis unit configured to estimate emotional information from first content including no emotional information; and a user content creator configured to convert the first content to second content using the estimated emotional information, the second content having emotional information suitable for a user environment according to which the user wants to consume content.

In another general aspect, there is provided a service providing apparatus including: an emotion analysis unit configured to estimate emotional information from content including no emotional information; and an emotion content creator configured to include the estimated emotional information in the content, thus creating the content including the emotional information.

In another general aspect, there is provided a service providing method including: analyzing emotional information from first content including the emotional information; and converting the first content to second content using the analyzed emotional information, the second content having emotional information suitable for a user environment according to which the user wants to consume content.

In another general aspect, there is provided a service providing method including: estimating emotional information from first content including no emotional information; and converting the first content to second content using the estimated emotional information, the second content having emotional information suitable for a user environment according to which the user wants to consume content.

The service providing apparatus and method may be applied to video and audio equipment, such as a TV, DMB, a PC, and so on.

The service providing apparatus and method may include configurations as follows:

a configuration of adding emotional information to general content (that is, creating content into which emotional information is inserted); and

a configuration of extracting emotional (additional) information from general content and adding the emotional information to the general content.

Here, the content includes images and voices used in a TV, DMB, a mobile phone, etc.

The service providing apparatus and method may include a configuration of extracting emotional information from content including the emotional information and converting the content according to a user's environment setting based on the emotional information.

The service providing apparatus and method may include a configuration of logging emotional information to use content according to a user emotion.

Accordingly, a user extracts and analyzes emotional information of a received service or content to use the service or content according to the user's environment setting.

Emotional information that a service or content itself represents is analyzed or extracted.

Emotional information that content itself represents is extracted directly from a user's device and controlled according to conditions requested by the user.

Other features and aspects will be apparent from the following detailed description, the drawings, and the claims.

### BRIEF DESCRIPTION OF THE DRAWINGS

FIG. 1 shows an example of content into which emotional information is inserted.

FIG. 2 is a diagram illustrating an example of a service providing apparatus.

FIGS. 3A and 3B are flowcharts illustrating examples of service providing methods that are performed by a service providing apparatus and a service receiving apparatus, respectively.

FIG. 4 is a flowchart showing an example of a service providing method, which is illustrated according to a flow of content.

FIG. 5 is a view for explaining an example of an emotion-based, personalized multimedia providing system.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

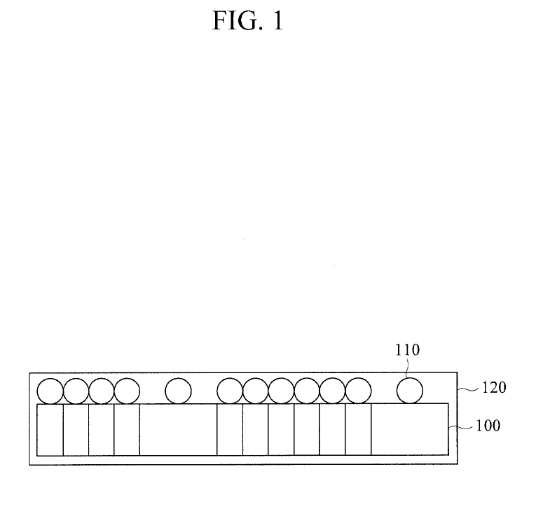

FIG. 1 shows an example of content into which emotional information is inserted.

When a service or content including voice or images is provided from a service providing apparatus and displayed or provided to a user, the user may have specific feelings with respect to the service or content. The feelings are generally called “emotions”, and the emotions means mixed emotions (gratefulness, agreeableness, pressure, etc.) that are evoked due to sensation or perception reacting to external physical stimuli obtained from human's experiences. In the specification, it is assumed that emotions can be implemented and applied by arbitrary methods that are designed to scientifically measure and analyze such emotions.

Referring to FIG. 1, the user's emotion evoked from voice or images provided by the content 100 is analyzed and predicted, and the emotional information 110 representing the analyzed/predicted emotion is inserted or added to a content region including information about a part at which the emotion is evoked to thus create new content 120 including the emotional information 110, so that the user can acquire refined content that matches his or her taste.

For example, in the case of movie content, emotional information is inserted into regions or frames at which the corresponding emotion is evoked throughout the flow of the plot, thus creating content with the emotional information.

Accordingly, customized content may be provided to users using the new content 120.

According to an example, emotional information representing human's emotions with respect to specific scenes including violence, words of abuse, sexual acts, etc., in movie is is inserted into the scenes at which the emotions are evoked, thus creating content with the emotional information. If a user who uses the content sets a user environment under which the corresponding scenes into which emotional information is inserted are not displayed, the emotional information of the content is analyzed while the movie is playing, and the scenes are deleted or modified in order not to be transferred as they are to the user.

Also, in regard of a voice call service, a service of removing or limiting specific expressions such as words of abuse that evoke negative emotions can be provided through real-time analysis on emotional information of voice content. Therefore, voice content from which specific expressions are removed or limited may be provided to users before the voice content is transferred as it is to them.

However, the example described above is only the simplest aspect of the present invention, and in this specification, a system capable of providing a user with content that matches the user's desired environment through insertion of emotional information into content or real-time analysis on emotional information of content is provided.

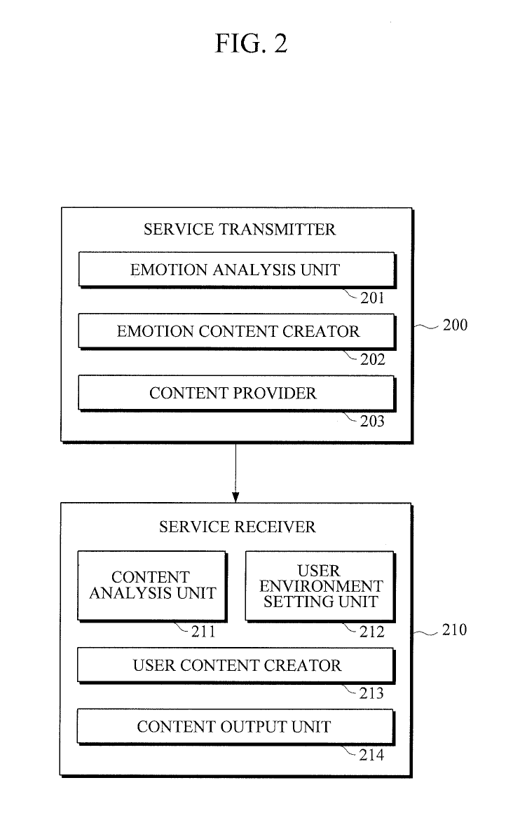

FIG. 2 is a diagram illustrating an example of a service providing apparatus. Referring to FIG. 2, the service providing apparatus may include a service transmitter 200 and a service receiver 210. The service transmitter 200 and the service receiver 210 may be individual user terminals or may be integrated into a single user terminal.

The service transmitter 200 is used to provide emotion content that a service providing apparatus possesses, and includes an emotion analyzer 201, an emotion content creator 202, and a content provider 203.

The emotion analyzer 201 scientifically analyzes human's emotions that are evoked with respect to a service or content provided from the service providing apparatus to estimate numerical emotion information.

The emotional information may include all human's emotions including joy, anger, sorrow, and pleasure which a human can feel through his or her five senses.

The emotion content creator 202 may create content including emotional information. In detail, the emotion content creator 202 may create content including emotional information by inserting emotional information analyzed by the emotional analyzer 201 into a specific region or frame of a service or content that is to be provided. The specific region or frame of the service or content corresponds to a region or frame from which the emotional information is analyzed and extracted. The emotion content creator 202 may convert content that is to be provided to new content with the analyzed emotional information.

The content provider 203 transmits the content including the emotional information to a user terminal through a wired/wireless communication network so that the user can receive and use the content.

The service receiver 210 may be installed in a user terminal, and includes a content analyzer 211, a user environment setting unit 212, a user content creator 213, and a content output unit 214.

The content analyzer 211 receives content including emotional information from the service transmitter 200 and may analyze the emotional information of the content. The content analyzer 211 may determine a psychological state such as a human's emotion that can be evoked with respect to the content to estimate the emotional information. The content analyzer 211 may extract the analyzed emotional information or the estimated emotional information as emotional information.

The user environment setting unit 212 sets a user environment of the user terminal to limit or control a part or region including specific emotional information in the content represented by voice or images when the user wants to receive content through the user terminal.

The user environment may be set in various ways, such as limiting a service or content including the specific emotional information or controlling only a part including the specific emotional information. That is, instead of simply searching for and processing specific emotional information, a user environment setting allows various applications such as converting content having a high rating level to content having a low rating level.

Also, instead of receiving a user's environment setting directly from the user, the user environment setting unit 212 may acquire information about a user who wants to receive content, such as the user's external environment, the user's age, the user's sex, etc., from the service receiver 210 or another device to determine whether or not to provide the content to the user. The user environment setting unit 212 may acquire the information about the user through a device such as a camcorder or a microphone which is installed in the user's terminal.

The user content creator 213 uses the emotional information acquired through the content analysis to convert the content according to the user environment setting, thereby creating appropriate content for the user.

The process described above may be conducted after receiving content that is to be provided to the user in real time or after storing content converted according to the user's environment in advance so that the content can be provided to the user directly in response to a request from the user.

The content output unit 214 provides the content converted according to the user's environment by the user content creator 213 directly to the user, according to the content's kind and type, through a predetermined device (for example, a monitor, a speaker, an earphone, etc.) included in the user terminal.

In addition, information (that is, the user environment, the content's kind, etc.) about the content created by the user content creator 213 may be processed as the user's preference information, etc., and stored in database (DB). Accordingly, it may be considered a method of automatically converting, when content having the same or similar characteristics is provided to the user, the content with reference to the user's preference information, etc. stored in the DB to provide the converted content.

The above description for the service providing apparatus illustrated in FIG. 2 relates to the case where the service transmitter 200 inserts emotional information into a service or content that is to be provided to a user, however, it is also possible that the service transmitter 200 provides only content and the content analyzer 211 of the service receiver 210 includes the function of the emotion analyzer 201 of directly analyzing emotional information that is evoked by content so that the service receiver 210 can create customized content.

In order to implement the function of the emotion analyzer 201 in the service receiver 210, an emotional information derivation technique for automatically analyzing emotional information from content is needed. Various emotional information derivation techniques may be used to analyze or extract emotional information of content.

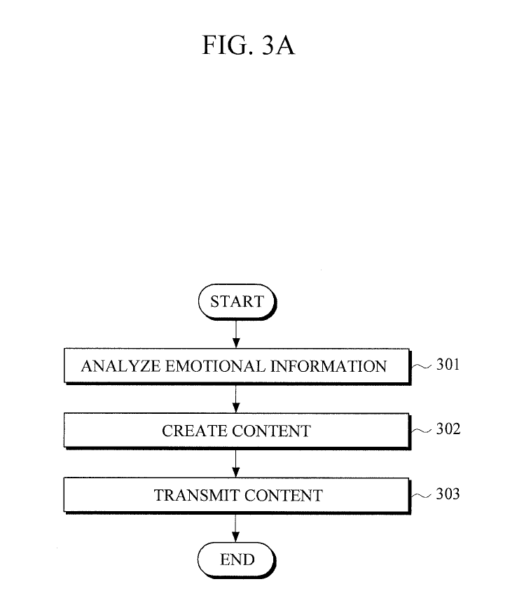

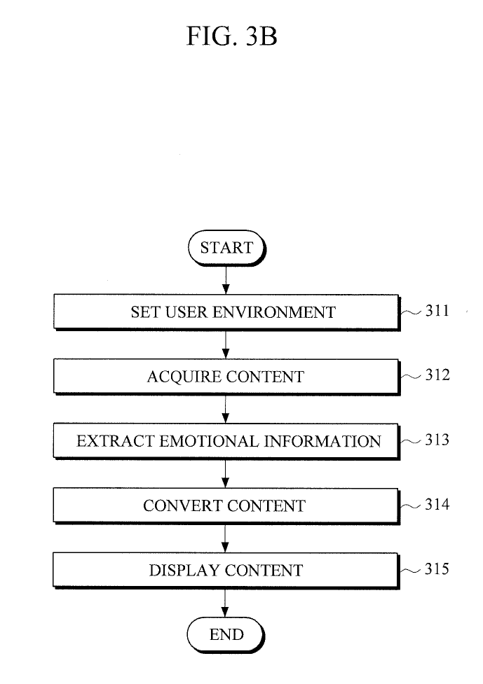

FIGS. 3A and 3B are flowcharts illustrating examples of service providing methods that are performed by a service providing apparatus and a service receiving apparatus, respectively.

FIG. 3A is a flowchart illustrating an example of a process in which the service providing apparatus processes and provides a service or content. The service providing apparatus may be the service transmitter 200 of FIG. 2.

Referring to FIG. 3A, first, the service providing apparatus collects a work, such as music, movie, etc., which was produced by an author, as content that is to be provided to a user.

Then, the service providing apparatus may digitize emotions that can be evoked in human from the content to extract the emotional information of the content (301). The emotional information may be extracted by dividing the content into a plurality of regions or parts that are differentiated according to changes in human's emotion over the entire content.

Then, the service providing apparatus inserts the extracted emotional information into the corresponding region of the content, thereby creating new content including the emotional information (302). The newly created content is stored in content DB, etc. of the service providing apparatus, and provided to a user in response to a request for the content from the user (303).

FIG. 3B is a flowchart illustrating an example of a process in which the service receiving apparatus processes and consumes a service or content according to a user environment. The service receiving apparatus may be the service receiver 210 of FIG. 2.

Referring to FIG. 3B, first, the service receiving apparatus requests the service providing apparatus to transmit a service or content which a user wants to receive, and sets a user environment to consume the content in the user's desired manner (311). The user environment may be set in such a manner as to receive or exclude only a service or content belonging to a predetermined range of emotional information. In the case of video, the service receiving apparatus may set a user environment for changing a rating level of the content.

After the user environment setting is complete, the content is acquired from the service providing apparatus (312). The operation 311 of setting the user environment and the operation 312 of acquiring the content may be conducted in this order, however, it is also possible that the operation 312 of acquiring the content is performed prior to the operation 311 of setting the user environment or that a user environment is set while content is acquired from the service providing apparatus. That is, the operations 311 and 312 may be performed in an appropriate order according to a system state.

Then, the service receiving apparatus extracts emotional information from the content (313). The emotional information may be extracted through direct analysis on the content. Next, since the emotional information is mapped to a part of the content, the content is converted to new content including a content region having an appropriate level of emotional information suitable for the user environment (314). Successively, the service receiving apparatus displays the converted content for the user (315).

Here, the content may be converted by removing or modifying the corresponding content region or substituting the content region with a different region.

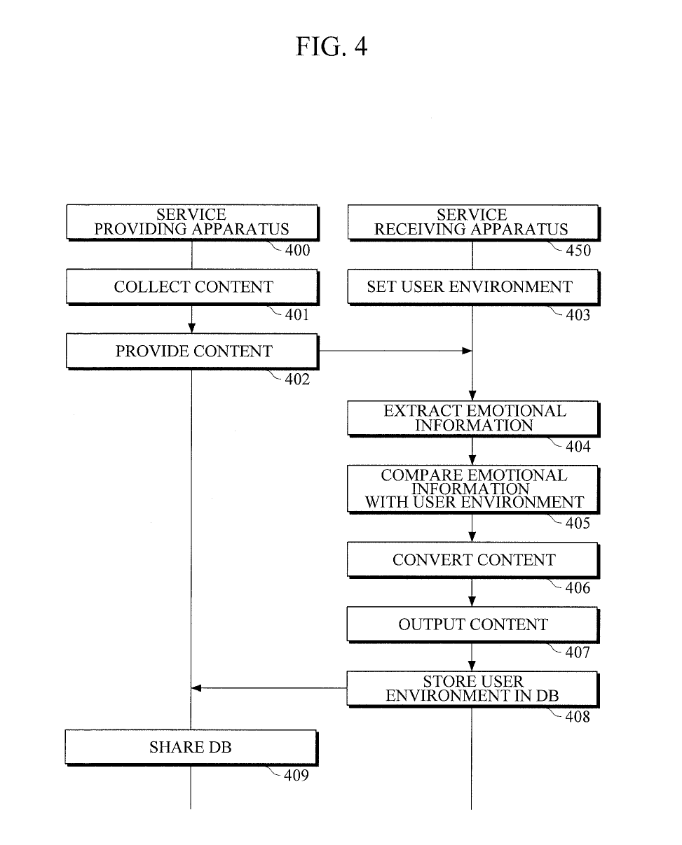

FIG. 4 is a flowchart showing an example of a service providing method, which is illustrated according to a flow of content. Referring to FIG. 4, the flow of content is basically from a service providing apparatus 400 to a service receiving apparatus 450.

First, the service providing apparatus 400 collects a work, such as music, movie, etc., which was produced by an author, as content that is to be provided to a user (401).

The content includes emotional information, and may be divided into a plurality of regions or parts that are differentiated according to changes in human's emotion over the entire content.

Then, the service providing apparatus 400 provides the content to the service receiving apparatus 450 (402). The content may be content into which numerical emotional information about emotions, etc. that can be evoked in human with respect to the content is analyzed and inserted. Or, the content may be a work converted to a format that can be provided to the service receiving apparatus 450 without the emotional information.

The content may be provided in response to a request for the content from the service receiving apparatus 450 or in response to a reserved request.

The service receiving apparatus 450 sets, when receiving content from the service providing apparatus 400 (including before or after receiving content from the service providing apparatus 400), a user environment to consume the content in a desired manner (403).

The user environment may be set in such a manner as to receive or exclude only a content region or a service region belonging to a predetermined range of emotional information. In the case of video, a user environment for changing a rating level may be set.

Then, the service receiving apparatus 450 extracts emotional information from the content (404). The emotional information may be extracted through direct analysis on the content or may be included in the content. Next, since the emotional information is mapped to a part of the content, the service receiving apparatus 450 compares the emotion information with the user environment in order to create new content including a content region having an appropriate level of emotional information suitable for the user environment (405). Then, the service receiving apparatus 450 converts the content to the new content using a content conversion method. The content conversion method may leave only the content region having the appropriate level of emotional information suitable for the user environment or remove a content region that does not match the user environment (406).

That is, the service receiving apparatus 450 may convert the content to new content by removing or modifying a content region that does not match the user environment or substituting the content region with a different region.

Finally, the converted content is output to the user's terminal so that the content can be consumed in the user's desired manner (407).

In addition, the user environment and information about the converted content are stored as data about the service receiving apparatus's content preferences, etc. in DB (408), and the DB shared with the service providing apparatus 400 (409).

Establishing DB for the service receiving apparatus 450 allows analysis on the user's personal tastes, etc. so that the service providing apparatus 400 can provide the user's preferred content or service or give advertisement about the user's preferred content or service. Accordingly, by establishing DB for service receiving apparatuses, a service providing apparatus may create a new business model that can provide an appropriate service suitable for the user, and service receiving apparatuses may receive their desired services without any efforts for searching services.

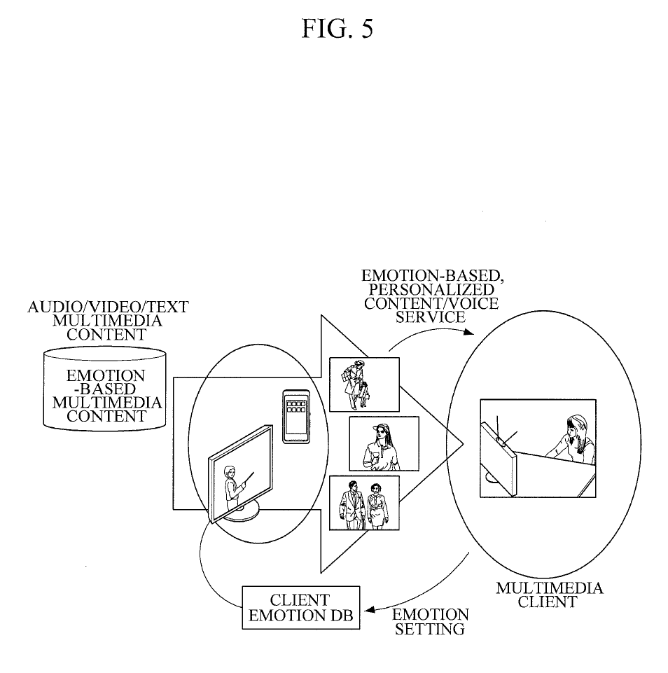

FIG. 5 is a view for explaining an example of an emotion-based, personalized multimedia providing system.

The emotion-based, personalized multimedia system sets, when providing a user with multimedia content (audio/video/text, etc.) or a voice call service including emotional information, a format (an emotion setting) in which the user wants to consume the multimedia content or the voice call service though the user's multimedia terminal (client), stores the format as data about the user's content/service preferences, etc. in client emotion DB, and then provides the user with an emotion-based, personalized content/voice service subject to processing such as conversion/removal based on emotional information.

FIG. 5 is a schematic, conceptual view of such an emotion-based, personalized multimedia providing system. Also, the emotion-based, personalized multimedia system may be implemented in other various ways by modifying the process of acquiring or extracting emotional information from a service or content or inserting emotional information into a service or content, the process of processing a service/content based on the emotional information, the process (an emotion setting) of setting a user environment for a user or a content/service consumer, etc., as described above.

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A service providing apparatus comprising:
a content analyzer configured to analyze emotional information from first content including the emotional information; and
a user content creator configured to convert the first content to second content using the analyzed emotional information, the second content having emotional information suitable for a user environment according to which the user wants to consume content.

2. The service providing apparatus of claim 1, wherein the user content creator converts the first content to the second content in a manner to receive or exclude only a part including specific emotional information in the first content.

3. The service providing apparatus of claim 1, further comprising a user environment setting unit configured to set the user environment under which a part including specific emotional information in the first content is able to be controlled.

4. The service providing apparatus of claim 1, further comprising a content output unit configured to output the second content.

5. The service providing apparatus of claim 1, further comprising:
an emotion analysis unit configured to estimate emotional information from third content including no emotional information; and
an emotion content creator configured to include the estimated emotional information in the third content, thus creating the third content including the emotional information as the first content.

6. The service providing apparatus of claim 1, further comprising database configured to store information about a user's preferences representing a user environment according to which the user wants to consume content,
wherein the user content creator converts the first content to the second content using the information about the user' preferences.

7. A service providing apparatus comprising:
a content analysis unit configured to estimate emotional information from first content including no emotional information; and
a user content creator configured to convert the first content to second content using the estimated emotional information, the second content having emotional information suitable for a user environment according to which the user wants to consume content.

8. The service providing apparatus of claim 7, wherein the user content creator converts the first content to the second content in a manner to receive or exclude only a part including specific emotional information in the first content.

9. The service providing apparatus of claim 7, further comprising a user environment setting unit configured to set the user environment under which a part including specific emotional information in the first content is able to be controlled.

10. A service providing apparatus comprising:
an emotion analysis unit configured to estimate emotional information from content including no emotional information; and
an emotion content creator configured to include the estimated emotional information in the content, thus creating the content including the emotional information.

11. The service providing apparatus of claim 10, further comprising a content providing unit configured to transmit the content including the emotional information to another terminal.

12. A service providing method comprising:
analyzing emotional information from first content including the emotional information; and
converting the first content to second content using the analyzed emotional information, the second content having emotional information suitable for a user environment according to which the user wants to consume content.

13. The service providing method of claim 12, wherein the converting of the first content to the second content comprises converting the first content to the second content in a manner to receive or exclude only a part including specific emotional information in the first content.

14. The service providing method of claim 12, further comprising setting the user environment under which a part including specific emotional information in the first content is able to be controlled.

15. The service providing method of claim 12, further comprising:
estimating emotional information from third content including no emotional information; and
including the estimated emotional information in the third content, thus creating the third content including the emotional information as the first content.

16. The service providing method of claim 12, wherein the converting of the first content to the second content comprising converting the first content to the second content using pre-stored information about a user's preferences representing a user environment according to which the user wants to consume content.

17. A service providing method comprising:
estimating emotional information from first content including no emotional information; and
converting the first content to second content using the estimated emotional information, the second content having emotional information suitable for a user environment according to which the user wants to consume content.

18. The service providing method of claim 17, wherein the converting of the first content to the second content comprising converting the first content to the second content in a manner to receive or exclude only a part including specific emotional information in the first content.

19. The service providing method of claim 17, further comprising setting the user environment under which a part including specific emotional information in the first content is able to be controlled.
